(19) United States
(12) Patent Application Publication
(10) Pub. No.: US 2025/0262907 A1
(43) Pub. Date: Aug. 21, 2025

(54) AIR CONDITIONER FOR VEHICLE

(71) Applicant: Hanon Systems, Daejeon (KR)

(72) Inventors: Yong Sik KIM, Daejeon (KR); Seung Min LEE, Daejeon (KR); Seung Ho LEE, Daejeon (KR); Jae Hyeon LIM, Daejeon (KR); Dae Keun PARK, Daejeon (KR); Jun Chul AN, Daejeon (KR); Sang Ki LEE, Daejeon (KR); Woo Hyun CHO, Daejeon (KR)

(73) Assignee: Hanon Systems, Daejeon (KR)

(21) Appl. No.: 19/048,435

(22) Filed: Feb. 7, 2025

(30) Foreign Application Priority Data
Feb. 15, 2024 (KR) 10-2024-0021880
Feb. 15, 2024 (KR) 10-2024-0021967

(51) Int. Cl. B60H 1/00

(52) U.S. Cl. CPC B60H 1/00664

(57) ABSTRACT

Disclosed is an air conditioner for a vehicle which can include: an air conditioning case in which an air passage and a plurality of air discharge ports are formed; and a cooling heat exchanger and a heating heat exchanger sequentially arranged in the air passage of the air conditioning case in an airflow direction, the air discharge ports include a defrost vent and a face vent, and a temperature channel is provided in an air passage inside the air conditioning case to guide cold air passing through the cooling heat exchanger to direct the discharge port of the defrost vent and guide warm air passing through the heating heat exchanger to direct the discharge port of the face vent.

### CROSS REFERENCE TO RELATED APPLICATIONS

The present application claims the benefit of priority to Korean Patent Application No. KR 10-2024-0021880, filed Feb. 15, 2024, and Korean Patent Application No. KR 10-2024-0021967, filed Feb. 15, 2024, each of which are incorporated herein by reference in their entirety.

### BACKGROUND OF THE PRESENT INVENTION

### Field of the Present Invention

The present invention relates to an air conditioner for a vehicle, and more specifically, to an air conditioner for a vehicle which improves temperature performance in a structure where a defrost vent and a face vent face a warm air passage.

### Background Art

In general, an air conditioner for a vehicle is a vehicle interior part that is installed for the purpose of cooling or heating the interior of the vehicle in the summer or winter or securing a driver's front and rear view by removing the frost from the windshield during the rainy or winter season. The air conditioner is usually equipped with a heating system and a cooling system to selectively introduce the indoor air or the outdoor air, heat or cool the air, and blow the heated or cooled air to the interior of the vehicle, thereby cooling, heating, or ventilating the interior of the vehicle.

Referring to FIG. 1, a conventional air conditioner 1 for a vehicle includes an air conditioning case 10, an evaporator 20 which is a cooling heat exchanger, an indoor condenser 30 which is a heating heat exchanger, and a temperature door 40. The evaporator 20 and the indoor condenser 30 are sequentially arranged inside the air conditioning case 10 in an air flow direction. Downstream of the indoor condenser 13 in the air flow direction, an electric heater such as a PTC heater can be provided.

The temperature door 40 adjusts the opening degree of a warm air passage 15 passing through the indoor condenser 30 and a cold air passage 14 bypassing the indoor condenser 30, thereby controlling the interior temperature of the vehicle. The air conditioning case 10 includes a plurality of air discharge ports. The air discharge ports include a defrost vent 11, a face vent 12, and a floor vent 13. The defrost vent 11 discharges wind towards the vehicle window, the face vent 12 discharges wind towards passengers' faces, and the floor vent 13 discharges wind towards the passengers' feet.

Additionally, the air conditioning case 10 includes a plurality of mode doors to control the opening degree of the air discharge ports. That is, the air conditioning case 10 includes a defrost door 51 for controlling the opening degree of the defrost vent 11, a vent door 52 for controlling the opening degree of the face vent 12, and a floor door 53 for controlling the opening degree of the floor vent 13. The temperature door 40 is designed in a sliding type, and has a rail-shaped guide groove 60 formed on the inner wall of the air conditioning case 10 to guide the temperature door 40.

The temperature door 40 has a driven gear 43 that meshes with a driving gear 70. The temperature door 40 slidably moves along the guide groove 60 by the rotation of the driving gear 70. The guide groove 60 extends in a convex arc shape in the wind direction, and the temperature door 40 is correspondingly curved to fit the guide groove 60. The driving gear 70 has a drive shaft 71 extending in the width direction of the door.

The conventional air conditioner for the vehicle have a structure in which the heat exchanger is arranged horizontally and the defrost vent 11 and face vent 12 face the warm air passage. Additionally, the discharge ports of the defrost vent 11 and the floor vent 13 are positioned to facilitate the flow of warm air, and the face vent 12 is located to facilitate the flow of cold air.

Therefore, in an air conditioning mode where air is discharged through the defrost vent 11 or the floor vent 13, an unintended vertical temperature inversion that the air discharged through the defrost vent 11 is hotter than intended often occurs. Furthermore, in an air conditioning mode where air is discharged through the face vent 12 and the floor vent 13, an excessive amount of cold air is discharged through the face vent 12 and an excessive amount of warm air is discharged through the floor vent 13, increasing the vertical temperature difference.

Additionally, the vent door 52 may include a constant discharge hole for continuously discharging air. However, the conventional air conditioner for the vehicle is difficult to control the amount of cold air discharged through the constant discharge hole, so it is difficult to satisfy the left-right temperature difference performance at the discharge port of the face vent 12.

### SUMMARY OF THE INVENTION

Accordingly, the present invention has been made to solve the above-mentioned problems occurring in the prior arts, and it is an objective of the present invention to provide an air conditioner for a vehicle which can reduce the temperature of air discharged through the defrost vent and increase the temperature of air discharged through the face vent, thereby preventing the increase of vertical temperature differences and suppressing the direct discharge of cold air through the constant discharge hole.

To accomplish the above object, according to the present invention, there is provided an air conditioner for a vehicle including: an air conditioning case in which an air passage and a plurality of air discharge ports are formed; and a cooling heat exchanger and a heating heat exchanger sequentially arranged in the air passage of the air conditioning case in an airflow direction, wherein the air discharge ports include a defrost vent and a face vent, and a temperature channel is provided in an air passage inside the air conditioning case to guide cold air passing through the cooling heat exchanger to direct the discharge port of the defrost vent and guide warm air passing through the heating heat exchanger to direct the discharge port of the face vent.

The temperature channel includes: a cold air guide part which guides the cold air passing through the cooling heat exchanger toward the discharge port of the defrost vent; and a warm air guide part which guides the warm air passing through the heating heat exchanger toward the discharge port of the face vent.

The cold air guide part prevents the warm air passing through the heating heat exchanger from directly moving toward the defrost vent and guides the cold air passing through the cooling heat exchanger to move to the discharge port of the defrost vent.

The defrost vent and the face vent are formed above the heating heat exchanger and face a warm air passage, the face vent is positioned further rearward in the vehicle than the defrost vent, and a cold air passage passing through the cooling heat exchanger is positioned further rearward in the vehicle than the warm air passage passing through the heating heat exchanger. The temperature channel is separately formed and coupled directly below the discharge port of the face vent in the air conditioning case.

A vent door is formed to slide and adjust the opening degree of the face vent, and the temperature channel includes a plate-shaped body part corresponding to a sliding path of the vent door. The warm air guide part is formed to penetrate the body part in the thickness direction, and the cold air guide part is formed along the sliding path of the vent door on the body part.

The warm air guide part penetrates both sides of the body part in the thickness direction to connect the face vent with the warm air passage.

A plurality of vertical partition walls protruding in the thickness direction is formed on one surface of the body part, and the vertical partition walls are spaced apart in the vehicle width direction. The cold air guide part is formed in a space between the vertical partition walls, and the cold air guide part and the warm air guide part are partitioned by the vertical partition walls.

The warm air guide part, the cold air guide part, and another warm air guide part are sequentially arranged in the temperature channel in the vehicle width direction, so that the cold air guide part is positioned between the warm air guide parts.

The warm air guide part, the cold air guide part, another warm air guide part, and another cold air guide part are sequentially arranged in the temperature channel in the vehicle width direction, so that the cold air guide parts and the warm air guide parts are alternately arranged in the vehicle width direction.

The warm air guide part is positioned further toward the side than the cold air guide part in the vehicle width direction.

The face vent includes a center vent and a side vent in the vehicle width direction, and the center vent and the side vent are respectively arranged to correspond to at least one of the cold air guide part and the warm air guide part in the vehicle width direction.

The air discharge port includes a floor vent provided on the side of the air-conditioning case, and the temperature channel includes a floor air guide part which guides the warm air passing through the heating heat exchanger to the discharge port of the floor vent. The floor air guide part is formed on the outermost side of the temperature channel in the vehicle width direction.

A horizontal partition wall crosses a through hole of the warm air guide part in the vehicle width direction to partially block the warm air guide part, and the horizontal partition wall is positioned to correspond to the end of the vent door in the sliding direction of the vent door during a bi-level mode where air is discharged to the face vent and the floor vent.

The face vent includes a center vent and a side vent in the vehicle width direction, and a constant discharge hole which allows air to continuously flow to the side vent is formed in the vent door. During the air conditioning mode which closes the face vent, the constant discharge hole is positioned inside the warm air guide part to be exposed to the through-hole of the warm air guide part.

In another aspect of the present invention, there is provided an air conditioner for a vehicle including: an air conditioning case in which an air passage and a plurality of air discharge ports are formed; and a cooling heat exchanger and a heating heat exchanger sequentially arranged in the air passage of the air conditioning case in an airflow direction, wherein the air discharge ports include a defrost vent and a face vent, a constant discharge hole is formed in a vent door adjusting the opening degree of the face vent to allow air to be continuously discharged to the face vent, and a temperature channel is provided in an air passage inside the air conditioning case to suppress cold air passing through the cooling heat exchanger from being discharged through the constant discharge hole.

The temperature channel guides the cold air passing through the cooling heat exchanger toward the discharge port of the defrost vent and guides the warm air passing through the heating heat exchanger toward the discharge port of the face vent. The temperature channel includes a warm air passage partition which blocks the cold air from being discharged to the constant discharge hole during a bi-level mode, where air is discharged to the face vent and the floor vent. The warm air passage partition crosses the through-hole of the warm air guide part in the vehicle width direction to partially block the warm air guide part.

The vent door is formed to slide and adjust the opening degree of the face vent, the temperature channel includes a plate-shaped body part corresponding to the sliding path of the vent door, the body part has a plurality of vertical partition walls protruding on one side of the body part in the thickness direction and spaced apart in the vehicle width direction, and the face vent includes a center vent and a side vent provided in the vehicle width direction. The warm air passage partition is formed on the body part at a position corresponding to the side vent to protrude from the vertical partition walls in the thickness direction of the vent door, thus blocking airflow between the cold air passage and the constant discharge hole.

The temperature channel includes a cold air blocking baffle which reduces the amount of cold air discharged to the face vent during the bi-level mode where the air is discharged to the face vent and the floor vent. The vent door is formed to slide and adjust the opening degree of the face vent, the temperature channel includes a plate-shaped body part corresponding to the sliding path of the vent door, the body part has a plurality of vertical partition walls protruding on one side of the body part in the thickness direction and spaced apart in the vehicle width direction, and the face vent includes a center vent and a side vent provided in the vehicle width direction. The cold air blocking baffle is formed protruding from the body part in the thickness direction of the vent door, crossing the cold air guide part in the vehicle width direction.

The temperature channel includes a cold air guide baffle which induces the cold air passing through the cooling heat exchanger toward the downstream side of the heating heat exchanger, increasing static pressure downstream of the heating heat exchanger. The vent door is formed to slide and adjust the opening degree of the face vent, and the temperature channel includes a plate-shaped body part corresponding to the sliding path of the vent door, and the cold air guide baffle is formed within the warm air guide part and extends side by side with the sliding direction of the vent door on the body part to direct air from the cold air passage toward a downstream space of the heating heat exchanger.

The air discharge port includes a floor vent provided on the side of the air-conditioning case, and the temperature channel includes a floor cold air guide baffle which guides the cold air passing through the cooling heat exchanger toward the floor vent. The vent door is formed to slide and adjust the opening degree of the face vent, and the temperature channel includes a plate-shaped body part corresponding to the sliding path of the vent door. The floor cold air guide baffle is formed within the warm air guide part and is inclined at a predetermined angle on the body part to guide the air from the cold air passage toward the floor vent.

The air conditioner for the vehicle according to the present invention can lower the temperature of air discharged through the defrost vent, thus preventing a passenger's head area from becoming hot during the air conditioning mode where air is discharged through the defrost vent and satisfying the temperature difference performance between the upper and lower discharge ports. Additionally, the air conditioner for the vehicle can increase the temperature of air discharged through the face vent, thus improving straightness of the air discharged through the face vent and satisfying the vertical temperature difference performance during the bi-level mode.

Furthermore, the air conditioner for the vehicle includes the temperature channel at a position where the discharge passages of the face vent, the floor vent, and the defrost vent overlap, thus maximizing the mixing effect in environments where a mixing zone space for cold air and warm air is insufficient.

Additionally, the air conditioner for the vehicle according to the present invention can suppress the direct discharge of cold air through the constant discharge hole. In addition, during the bi-level mode, the air conditioner for the vehicle can raise the temperature at the side vent discharge port and improve the left-right temperature difference performance. The air conditioner can reduce the amount of cold air flowing through the cold air guide part of the temperature channel, thereby increasing the discharge temperature. Moreover, the air conditioner for the vehicle can raise the static pressure in the downstream space of the electric heater, thus minimizing the influence of warm air crossing to the opposite side of the separator during the dual control for the driver's seat and the passenger's seat.

### BRIEF DESCRIPTION OF THE DRAWINGS

FIG. 1 is a side sectional view illustrating a conventional air conditioner for a vehicle.

FIG. 2 is a side sectional view illustrating an air conditioner for a vehicle according to a first embodiment of the present invention.

FIG. 3 is a perspective view illustrating the temperature channel of the air conditioner for the vehicle according to the first embodiment of the present invention.

FIG. 4 is a view illustrating an air flow within the temperature channel of the first embodiment of the present invention.

FIGS. 5 and 6 are perspective views illustrating a partial cutaway of the air conditioner for the vehicle according to the first embodiment of the present invention.

FIG. 7 is a perspective view illustrating the temperature channel and a separator according to the first embodiment of the present invention.

FIG. 8 is a plan view illustrating the air conditioner for the vehicle according to the first embodiment of the present invention.

FIG. 9 is a plan view illustrating a state where a face vent is closed in the air conditioner for the vehicle according to the first embodiment of the present invention.

FIG. 10 is an enlarged side sectional view illustrating a portion of the air conditioner for the vehicle according to the first embodiment of the present invention.

FIGS. 11 and 12 are views for depicting a cold air guide part and a warm air guide part of the temperature channel according to the first embodiment of the present invention.

FIGS. 13 and 14 are views for depicting a cold air guide part and a warm air guide part of the temperature channel according to a modification of FIG. 11.

FIG. 15 is a perspective view illustrating a temperature channel of an air conditioner for a vehicle according to a second embodiment of the present invention.

FIG. 16 is a view illustrating an air flow within the temperature channel of the second embodiment of the present invention.

FIGS. 17 and 18 are bottom perspective views of the temperature channel of the air conditioner for the vehicle according to the second embodiment of the present invention.

FIG. 19 is an enlarged perspective view illustrating a face vent area where the temperature channel of the second embodiment of the present invention is installed.

FIG. 20 is a view for depicting the function of a warm air passage partition of the temperature channel according to the second embodiment of the present invention.

FIG. 21 is a view for depicting the function of a cold air blocking baffle of the temperature channel according to the second embodiment of the present invention.

FIG. 22 is a view illustrating a change in installation position of the cold air blocking baffle in FIG. 21.

FIG. 23 is a view for depicting the function of a cold air guide baffle of the temperature channel according to the second embodiment of the present invention.

FIG. 24 is a view for depicting the function of a floor cold air guide baffle of the temperature channel according to the second embodiment of the present invention.

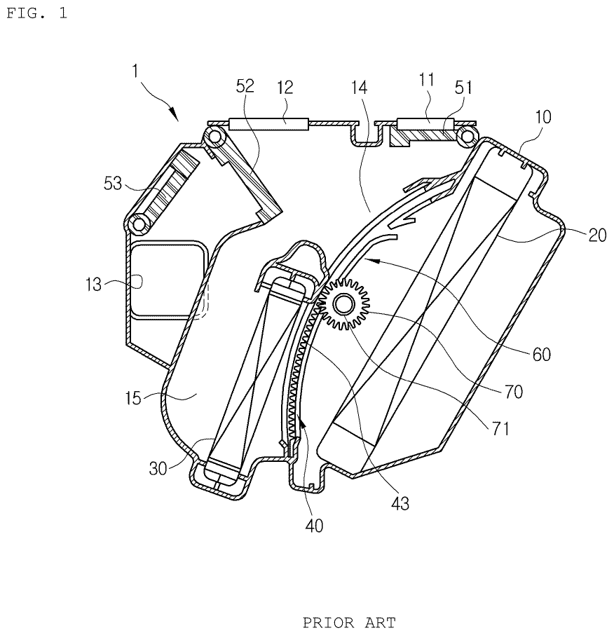

### DETAILED DESCRIPTION OF THE PREFERRED EMBODIMENT

Hereinafter, referring to the drawings, the technical configuration of an air conditioner for a vehicle will be described in detail.

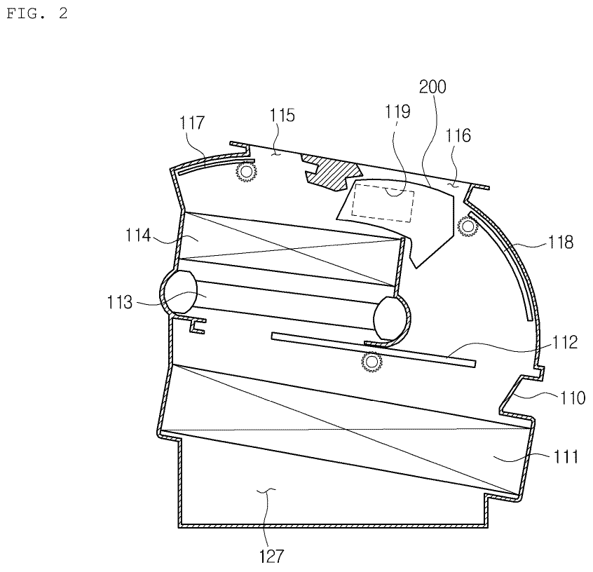

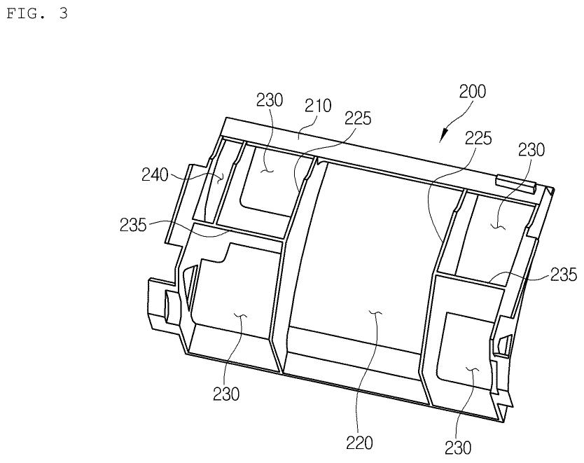

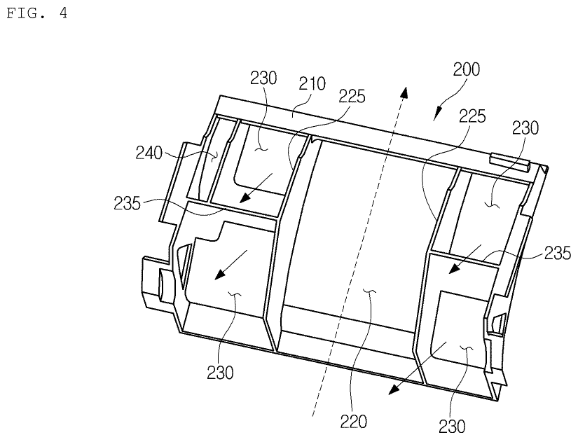

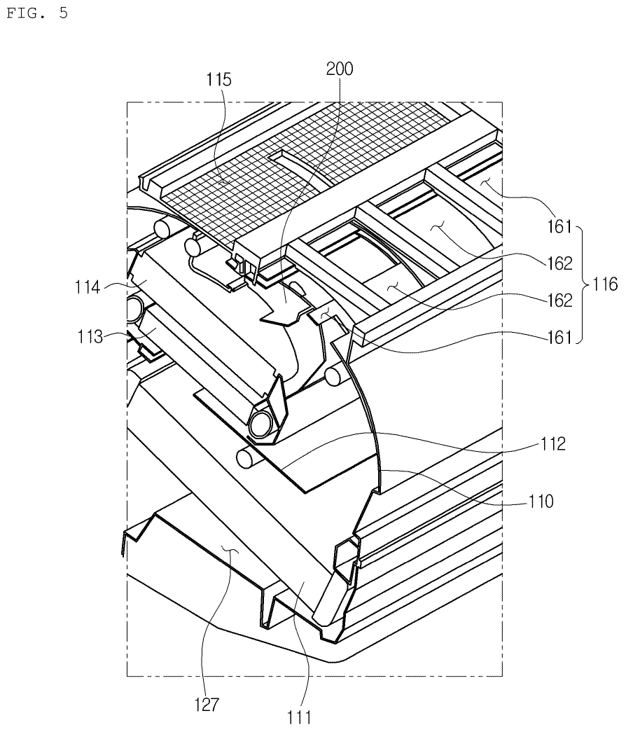

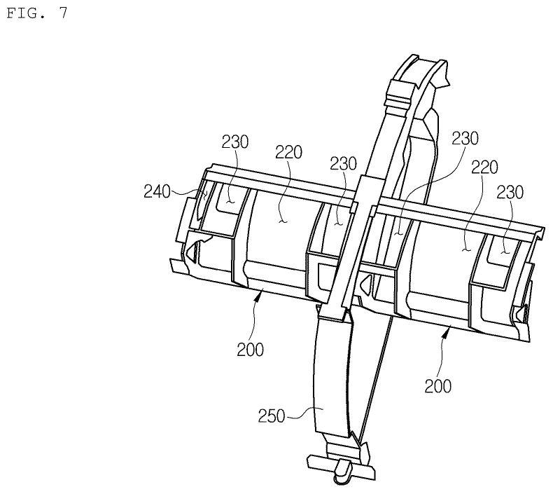

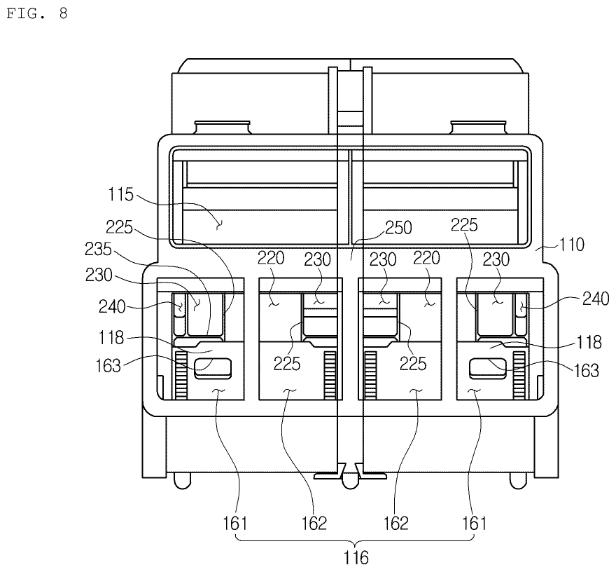

Referring to FIGS. 2 to 8, the air conditioner for a vehicle according to an embodiment of the present invention is a slim-type air conditioner with a horizontally arranged heat exchanger type, and has a relatively thin vertical width. The air conditioner for a vehicle according to an embodiment of the present invention includes an air conditioning case 110, a cooling heat exchanger, a heating heat exchanger, and a door. In the description below, the left-right direction in FIG. 2 corresponds to the vehicle's front-rear direction, while the left-right direction in FIG. 8 corresponds to the vehicle's width direction.

The air conditioning case 110 includes an air passage and is a slim type with a narrow vertical width. The air conditioning case 110 includes an air inflow port 127 and a plurality of air discharge ports. An air blower for blowing air into the air conditioning case 110 is connected to the air inflow port 127. The air blower selectively introduces inside air or outside air and blows the air into the air conditioning case 110.

Moreover, the air inflow port 127 is located below the cooling heat exchanger so that air flows from the bottom to the top. The air discharge ports of the air conditioning case 110 includes a defrost vent 115, a face vent 116, and a floor vent 119. The defrost vent 115 is formed to direct air toward the vehicle windows, the face vent 116 is formed to direct air toward the front seat passengers' faces, and the floor vent is formed to direct air toward the passengers' feet. The floor vent 119 is formed on the side of the air conditioning case 110 in the vehicle width direction to guide air toward the lower portion of the vehicle through a duct.

The cooling heat exchanger is an evaporator 111, and the heating heat exchanger is an indoor condenser 113. An electric heater 114 such as a PTC heater is provided downstream of the indoor condenser 113 in the airflow direction. The evaporator 111 and the indoor condenser 113 are connected in a refrigerant circulation line connecting a compressor, an expansion valve, etc., to act as a cooling means or a heating means depending on the refrigerant state. That is, the refrigerant passing through the evaporator 111 exchanges heat with air to cool the air, and the refrigerant passing through the indoor condenser 113 exchanges heat to heat the air.

The evaporator 111 and the indoor condenser 113 are sequentially arranged in the air passage of the air conditioning case 110 in the airflow direction. The evaporator 111, the indoor condenser 113, and the electric heater 114 are all arranged horizontally. That is, the internal passage of the air conditioning case 110 is vertically oriented relative to the ground, directing the airflow route from the lower part to the upper part in the direction of gravity. In addition, the cooling heat exchanger and the heating heat exchanger on the internal passage are arranged sequentially from the bottom to the top in the direction of gravity corresponding to the air flow route.

As described above, the heat exchangers are arranged horizontally relative to the ground surface or inclined at a predetermined angle to be close to the horizontal. That is, air is introduced into the air inflow port 127 at the lower side of the air conditioning case 110 and flows upwards. From below, the evaporator 111, the indoor condenser 113, and the electric heater 114 are arranged in sequence.

The air conditioner for a vehicle includes a temperature door 112 and a plurality of mode doors. The temperature door 112 is placed between the evaporator 111 and the indoor condenser 113. The temperature door 112 controls the opening degree between the warm air passage passing through the indoor condenser 113 and the cold air passage bypassing the indoor condenser 113 to adjust the interior temperature of the vehicle. That is, the temperature door 112 adjusts the amount of air passing through or the amount of air bypassing the indoor condenser 113 and the electric heater 114 according to the position thereof.

The temperature door 112 is a plate door that slides horizontally within the air conditioning case 110, adjusting the opening degree between the cold air passage and the warm air passage. The sliding-type temperature door 112 helps reduce the height of the air conditioning case 110. The mode doors include a defrost door 117 for adjusting the opening degree of the defrost vent 115, a vent door 118 for adjusting the opening degree of the face vent 116, and a floor door for adjusting the opening degree of the floor vent 119. In this case, the vent door 118 operates in a sliding type.

A separator 250 which divides the inside of the air conditioning case 110 into the left and right in a vehicle width direction is provided within the air conditioning case 110. The separator 250 divides the air passage of the air conditioning case 110 into the left and right, enabling right and left independent air conditioning for the driver's seat and the front passenger's seat. The air passage inside the air conditioning case 110 is divided into a left passage and a right passage by the separator 250.

Meanwhile, the face vent 116 includes a center vent 162 and side vents 161 arranged in the vehicle width direction. Specifically, the left passage divided by the separator 250 is partitioned into the center vent 162 and the side vent 161 by a partition wall, and the right passage is also divided into the center vent 162 and the side vent 161 by a partition wall. Consequently, the center vent 162 is formed at the central portion in the vehicle width direction, and the side vents 161 are positioned on both sides.

The air conditioner for the vehicle according to a first embodiment of the present invention includes a temperature channel 200. The temperature channel 200 is provided in the air passage inside the air conditioning case 110, and guides the cold air passing through the cooling heat exchanger toward the discharge port of the defrost vent 115 and the warm air passing through the heating heat exchanger toward the discharge port of the face vent 116.

The temperature channel 200 includes a cold air guide part 220, a warm air guide part 230, and a floor air guide part 240. The cold air guide part 220 guides the cold air passing through the cooling heat exchanger toward the defrost vent 115. The warm air guide part 230 guides the warm air passing through the heating heat exchanger toward the face vent 116. The floor air guide part 240 guides the warm air passing through the heating heat exchanger toward the floor vent 119.

Meanwhile, the defrost vent 115 and the face vent 116 are positioned above the heating heat exchanger and face the warm air passage. Additionally, the face vent 116 is located rearward of the defrost vent 115 in the vehicle. The cold air passage passing through the cooling heat exchanger is arranged rearward of the warm air passage passing through the heating heat exchanger. Furthermore, the vent door 118 is configured to slide, adjusting the opening degree of the face vent 116. As described above, the cold air passing through the evaporator 111 flows along the cold air passage and passes the face vent 116 before reaching the defrost vent 115. In contrast, the warm air passing through the indoor condenser 113 and the electric heater 114 flows along the warm air passage and is easily discharged through the defrost vent 115.

The temperature channel 200 suppresses the warm air from directly flowing toward the discharge port of the defrost vent 115, and guides the cold air to flow to the discharge port of the defrost vent 115. In other words, the temperature channel 200 guides the cold air passing through the evaporator 111 to flow toward the discharge port of the defrost vent 115, and guides the warm air passing through the indoor condenser 113 and the electric heater 114 to direct toward the discharge port of the face vent 116. Additionally, the temperature channel 200 adjusts the amount of warm air and the amount of cold air directing toward the discharge port of the floor vent 119.

Therefore, the temperature of the air discharged through the defrost vent 115 is lowered, preventing a passenger's head area from becoming hot during air conditioning modes such as a defrost mode, a mixing mode, and a floor mode, and satisfying the temperature difference performance between the upper and lower discharge ports. Furthermore, the temperature channel 200 can increase the temperature of the air discharged through the face vent 116, thus enhancing the straightness of the air discharged to the face vent 116 and improving the vertical temperature difference performance during a bi-level mode.

The temperature channel 200 is separately formed and coupled to the air conditioning case 110 directly below the discharge port of the face vent 116. More specifically, the temperature channel 200 includes a body part 210, vertical partition walls 225, and horizontal partition walls 235. The body part 210 is slightly curved and shaped to correspond to a sliding path of the vent door 118. If the vent door 118 slides in a straight line, the body part 210 is straight to correspond to the sliding path of the vent door 118. Alternatively, as in this embodiment, if the vent door 118 slides in a streamlined manner, the body part 210 is also streamlined to match the sliding path of the vent door 118.

The warm air guide part 230 is formed to penetrate the body part 210 in the thickness direction. When the temperature channel 200 is installed in the air conditioning case 110, the warm air guide part 230 is formed to penetrate in the vertical direction. That is, the warm air guide part 230 penetrates both sides of the body part 210 in the thickness direction to connect the warm air passage and the face vent 116. The warm air passing through the indoor condenser 113 and the electric heater 114 is discharged upward toward the face vent 116 directly above through a through-hole of the warm air guide part 230.

The cold air guide part 220 prevents the warm air passing through the heating heat exchanger from directly moving toward the defrost vent 115 and guides the cold air passing through the cooling heat exchanger to move to the discharge port of the defrost vent 115. The cold air guide part 220 is formed on the body part 210 along the sliding path of the vent door 118. The cold air guide part 220 is located on the upper surface of the body part 210. The vent door 118 slides directly above the temperature channel 200. In other words, the cold air guide part 220 is formed in a space between the body part 210 and the vent door 118 in the vertical direction.

The plurality of vertical partition walls 225 are formed on one surface of the body part 210 to protrude in the thickness direction. The vertical partition walls 225 are spaced apart from each other in the vehicle width direction. The cold air guide part 220 is defined by a space between the vertical partition walls 225. That is, the cold air guide part 220 is formed in the space between the vertical partition walls 225. Additionally, the vertical partition walls 225 act as bulkheads to partition the cold air guide part 220 from the warm air guide part 230. When the spacing between the vertical partition walls 225 is adjusted, the width of the cold air guide part 220 can be varied.

Since the temperature channel 200 is separately manufactured and assembled into the air conditioning case 110, the vertical partition walls 225 can be molded to have different spacings according to the specifications of the air conditioner installed in the vehicle. Thus, the temperature channel 200 can be easily applied to various specifications by varying shape of the temperature channel 200, the position of its through-holes, and the spacing and alignment of partition walls including the vertical partition walls 225, without requiring a change in the entire design of the air conditioning case 110.

The cold air guide part 220 and the warm air guide part 230 are partitioned by the vertical partition walls 225. Therefore, the air conditioner for the vehicle according to the present invention can enhance the left-right temperature difference performance in the vehicle width direction by adjusting the widths of the cold air guide part 220 and the warm air guide part 230.

The warm air guide part 230 is positioned toward the side relative to the cold air guide part 220 in the vehicle width direction. Consequently, relatively warm air is discharged through the side vents 161, and relatively cold air is discharged through the center vents 162, thus improving air conditioning performance and enhancing passenger satisfaction with the air conditioner. Additionally, the floor air guide part 240 is formed on the outermost side of the temperature channel 200 in the vehicle width direction. Since the floor vent 119 is located on the side of the air conditioning case 110 and serves as a heating discharge port, the air discharged through the floor vent 119 can adequately meet the demand for warm air, which is more required than cold air.

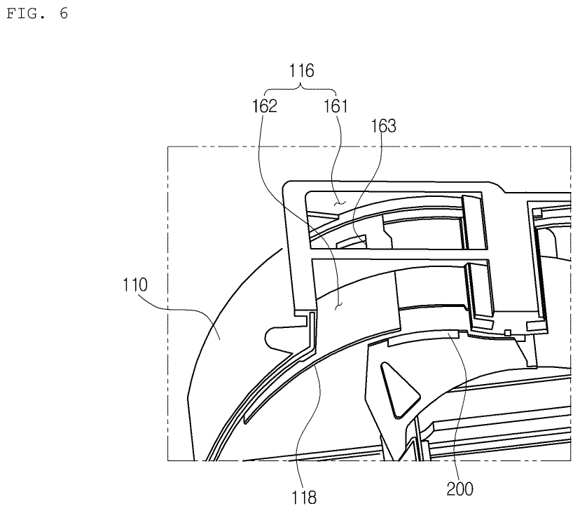

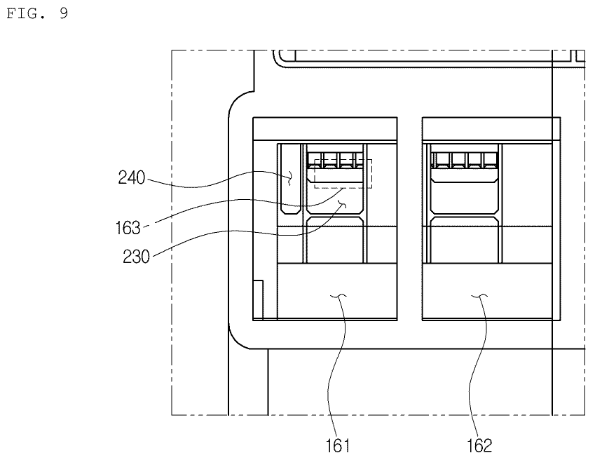

As illustrated in FIG. 6, a constant discharge hole 163 is formed on the vent door 118. The constant discharge hole 163 penetrates the vent door 118 in the thickness direction (vertical direction), allowing air to be continuously discharged to the side vent 161. Referring further to FIG. 9, in the air conditioning mode where the vent door 118 closes the face vent 116, the constant discharge hole 163 is positioned inside the warm air guide part 230 to be exposed to the through-hole of the warm air guide part 230. In this case, the air conditioning mode where the vent door 118 closes the face vent 116 may include the floor mode, the mixing mode, and the defrost mode. Accordingly, air, primarily warm air, is discharged through the constant discharge hole 163, enabling efficient temperature control.

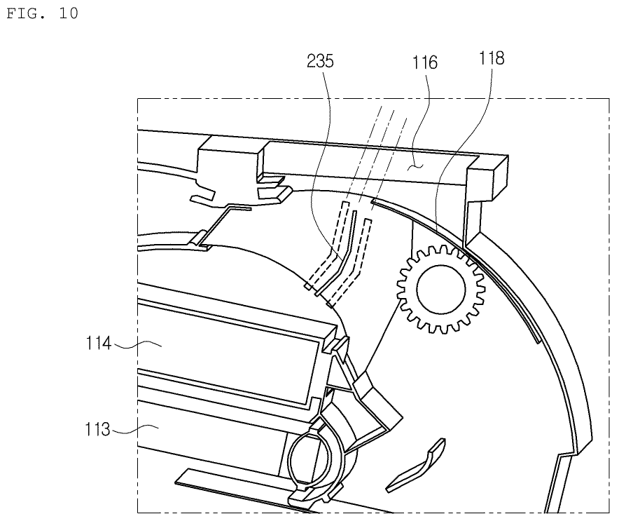

The horizontal partition wall 235 is formed across the through-hole of the warm air guide part 230 in the vehicle width direction. The horizontal partition wall 235 partially covers the through-hole of the warm air guide part 230. Additionally, referring to FIG. 10, the horizontal partition wall 235 is positioned to correspond to the end of the vent door 118 in a sliding direction of the vent door 118 during the bi-level mode. The bi-level mode is an air conditioning mode that discharges air to the face vent 116 and the floor vent 119.

As described above, the position of the horizontal partition wall 235 is related to the position of the sliding-type vent door 118. During the bi-level mode, the vent door 118 partially opens the face vent 116 to an intermediate degree. During the bi-level mode, the position of the horizontal partition wall 235 at the position of the vent door 118 can be selected to coincide with the end of the vent door 118 or be exposed. Preferably, during the bi-level mode, the horizontal partition wall 235 is positioned within approximately 10 mm forward or backward of the end of the vent door 118. As described above, each area of the temperature channel 200 influences the temperature at the discharge port of the face vent 116.

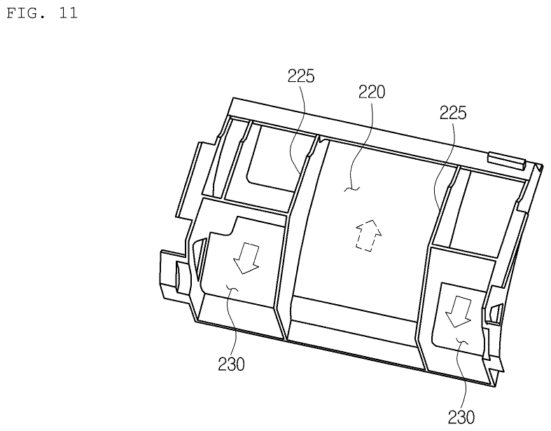

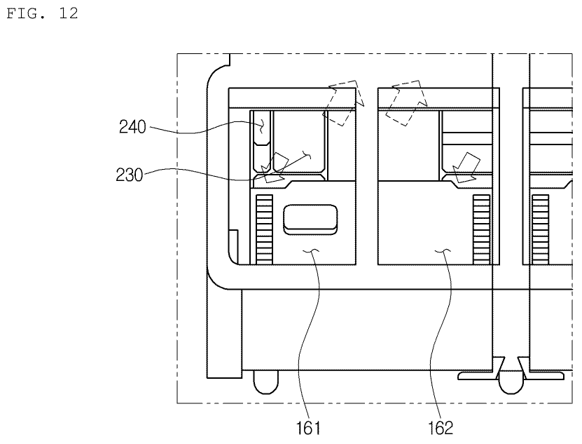

Referring to FIGS. 11 and 12, the warm air guide part 230, the cold air guide part 220, and another warm air guide part 230 are sequentially arranged in the temperature channel 200 in the vehicle width direction. That is, the cold air guide part 220 is located between the warm air guide parts 230 in the vehicle width direction. The temperature channel 200 is assembled in pairs on both sides of the air conditioning case 110 based on the separator 250. Thus, the cold air guide part 220 and the warm air guide part 230 are respectively arranged on the side vent 161 and center vent 162 at the left side based on the separator 250, and the cold air guide part 220 and the warm air guide part 230 are also arranged on the side vent 161 and center vent 162 at the right side.

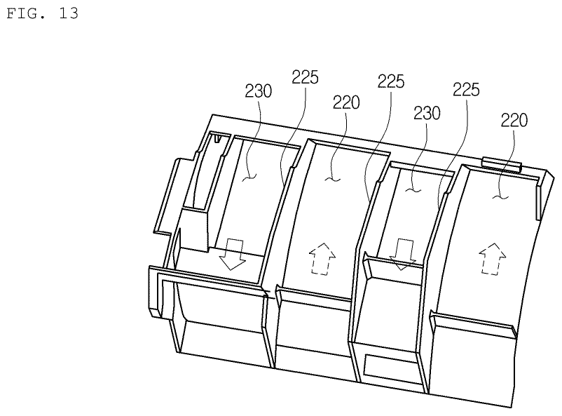

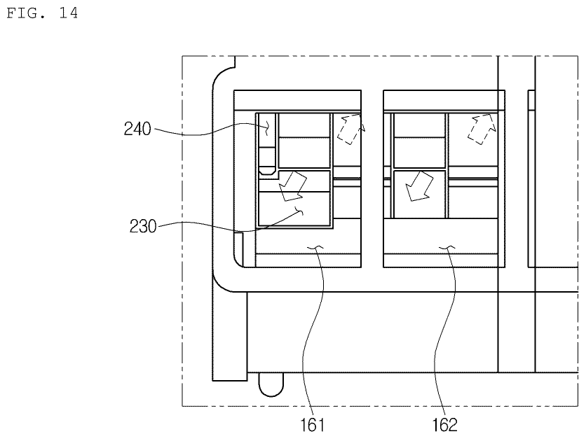

Referring further to FIGS. 13 and 14, the warm air guide part 230, the cold air guide part 220, another warm air guide part 230, and another cold air guide part 220 are sequentially arranged in the temperature channel 200 in the vehicle width direction. That is, the cold air guide part 220 and the warm air guide part 230 are alternately arranged in the vehicle width direction. Thus, the cold air guide part 220 and the warm air guide part 230 are respectively arranged on the side vent 161 and center vent 162 at the left side based on the separator 250, and the cold air guide part 220 and the warm air guide part 230 are also arranged on the side vent 161 and center vent 162 at the right side.

As described above, the center vent 162 and the side vent 161 are arranged such that at least one cold air guide part 220 and at least one warm air guide part 230 correspond to each other in the vehicle width direction. Therefore, the air conditioner for the vehicle according to the present invention can effectively meet the desired air conditioning performance and temperature by adjusting the ratio of the cold air guide part 220 to the warm air guide part 230.

The present invention includes the temperature channel 200 provided at a position where the discharge passages of the face vent 116, floor vent 119, and defrost vent 115 overlap, thereby maximizing the mixing effect of cold and warm air in environments with limited mixing zone space by incorporating the temperature channel 200 at positions where the mixing zone space for cold air and warm air is insufficient.

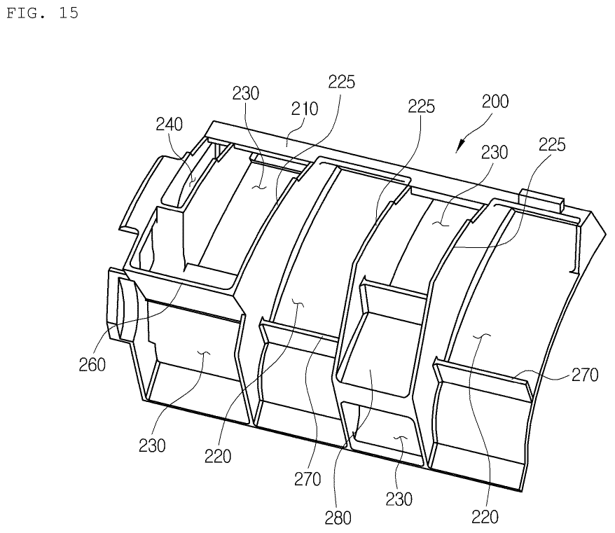

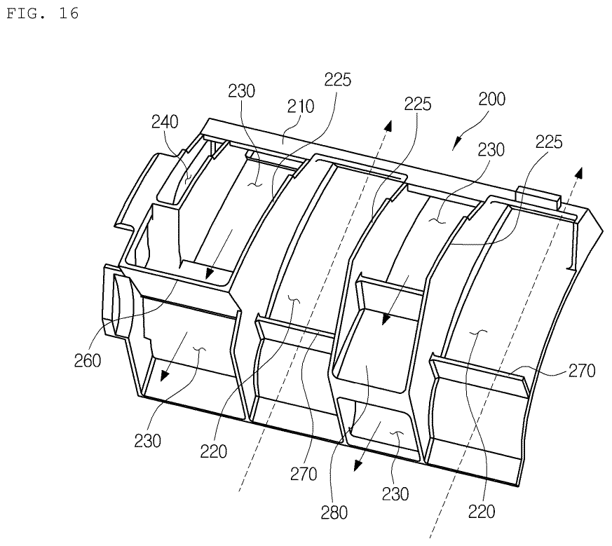

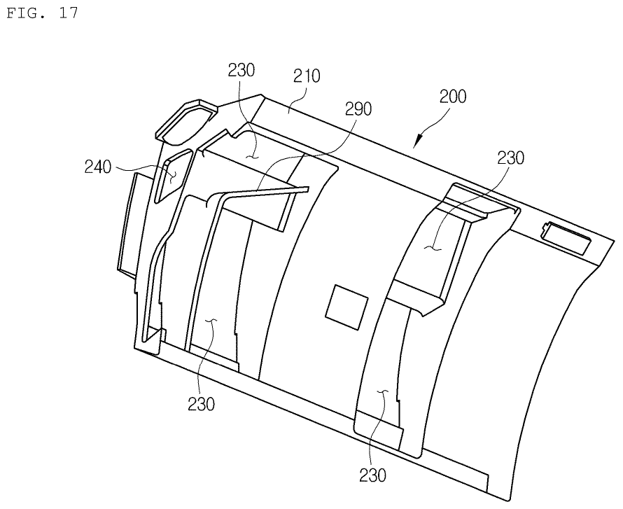

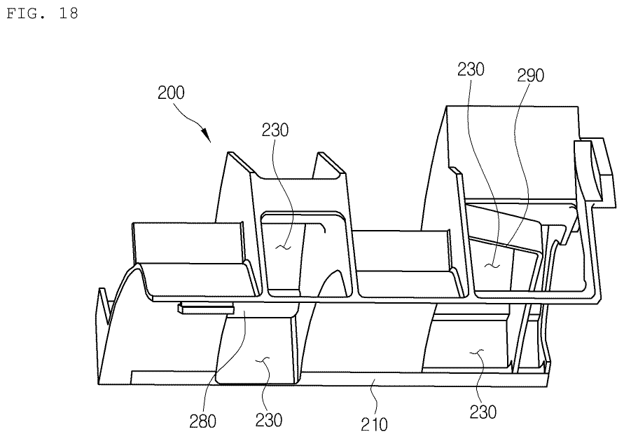

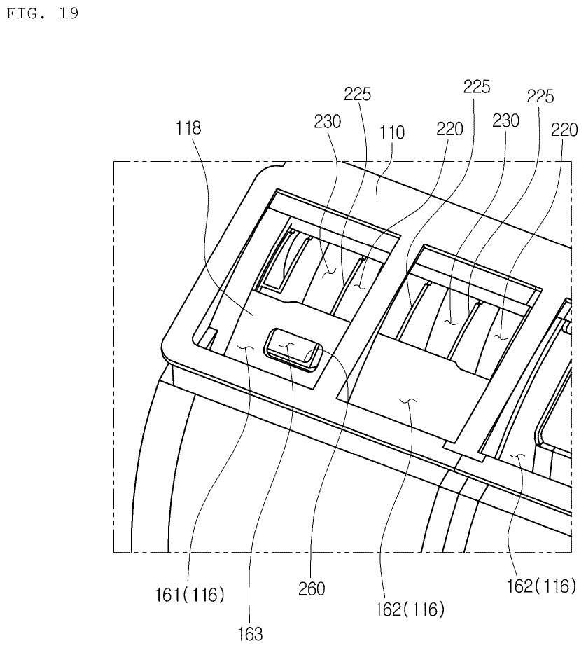

Referring to FIGS. 15 to 24, an air conditioner for a vehicle according to a second embodiment of the present invention includes a temperature channel 200. The second embodiment will be described only for the configurations differing from the first embodiment. The temperature channel 200 is formed within the air passage of the air conditioning case 110 and functions to prevent cold air passing through the cooling heat exchanger from being discharged through the constant discharge hole 163 of the vent door 118. The temperature channel 200 includes a cold air guide part 220, a warm air guide part 230, and a floor air guide part 240.

The temperature channel 200 is separately formed and coupled to the air conditioning case 110 directly below the discharge port of the face vent 116. More specifically, the temperature channel 200 includes a body part 210 and vertical partition walls 225. The body part 210 is slightly curved and shaped to correspond to a sliding path of the vent door 118. If the vent door 118 slides in a straight line, the body part 210 is straight to correspond to the sliding path of the vent door 118. Alternatively, as in this embodiment, if the vent door 118 slides in a streamlined manner, the body part 210 is also streamlined to match the sliding path of the vent door 118.

The floor air guide part 240 is positioned at the outermost side of the temperature channel 200 in the vehicle width direction. Since the floor vent 119 is located on the side of the air conditioning case 110 and serves as a heating discharge port, the air discharged through the floor vent 119 can adequately meet the demand for warm air, which is more required than cold air.

Additionally, the warm air guide part 230, the cold air guide part 220, another warm air guide part 230, and another cold air guide part 220 are sequentially arranged within the temperature channel 200 in the vehicle width direction. That is, the cold air guide part 220 and the warm air guide part 230 are alternately arranged in the vehicle width direction. Accordingly, the cold air guide part 220 and the warm air guide part 230 are respectively arranged on the side vent 161 and center vent 162 at the left side based on the separator 250, and the cold air guide part 220 and the warm air guide part 230 are also arranged on the side vent 161 and center vent 162 at the right side.

As described above, the center vent 162 and the side vent 161 are arranged such that at least one cold air guide part 220 and at least one warm air guide part 230 correspond to each other in the vehicle width direction. Therefore, the air conditioner for the vehicle according to the present invention can effectively meet the desired air conditioning performance and temperature by adjusting the ratio of the cold air guide part 220 to the warm air guide part 230. The present invention includes the temperature channel 200 provided at a position where the discharge passages of the face vent 116, floor vent 119, and defrost vent 115 overlap, thereby maximizing the mixing effect of cold and warm air in environments with limited mixing zone space by incorporating the temperature channel 200 at positions where the mixing zone space for cold air and warm air is insufficient.

Meanwhile, the temperature channel 200 also includes a warm air passage partition 260, a cold air blocking baffle 270, a cold air guide baffle 280, and a floor cold air guide baffle 290.

The warm air passage partition 260 prevents cold air from being discharged to the constant discharge hole 163 during the bi-level mode. The bi-level mode is an air conditioning mode that discharges air through both the face vent 116 and the floor vent 119. The warm air passage partition 260 partially blocks the through-hole of the warm air guide part 230 in the vehicle width direction. The warm air passage partition 260 is positioned to block the constant discharge hole 163 at the position of the vent door 118 during the bi-level mode.

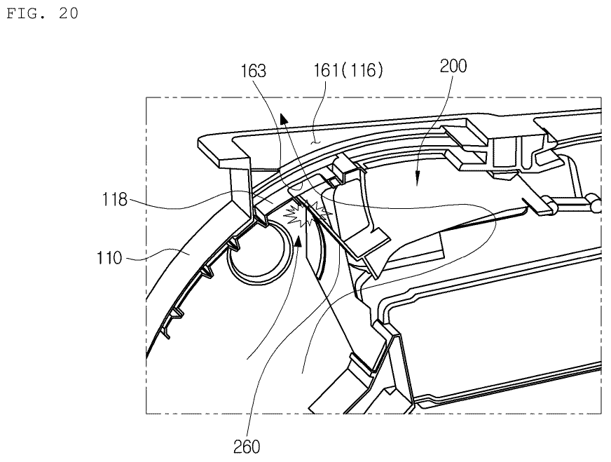

That is, the warm air passage partition 260 is formed at the location corresponding to the side vent 161 to protrude from the vertical partition walls 225 in the thickness direction of the vent door 118, blocking the airflow between the cold air passage and the constant discharge hole 163. As illustrated in FIG. 20, the warm air passage partition 260 extends to cover the constant discharge hole 163, preventing cold air from being discharged to the constant discharge hole 163 formed in the vent door 118 during the bi-level mode. The warm air passage partition 260 is further extended from the top of the vertical partition walls 225 to form a step with the vertical partition walls 225.

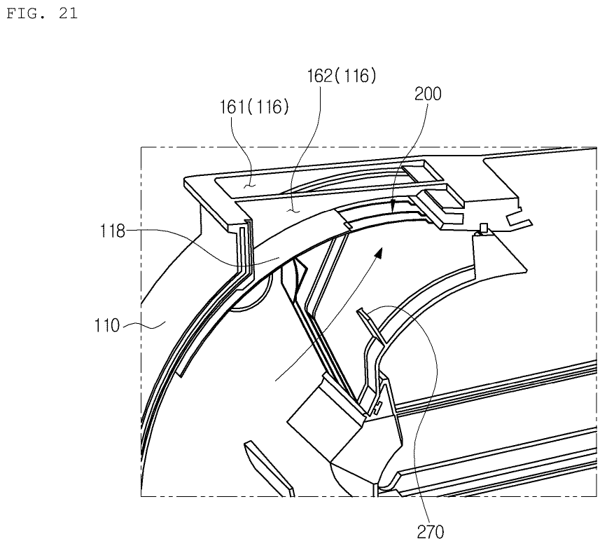

The cold air blocking baffle 270 reduces the amount of cold air discharged to the face vent 116 during the bi-level mode. The cold air blocking baffle 270 is formed protruding from the body part 210 in the thickness direction of the vent door 118, crossing the cold air guide part 220 in the vehicle width direction. That is, as illustrated in FIG. 21, the cold air blocking baffle 270 protrudes upward from the upper surface of the body part 210 corresponding to the cold air guide part 220, blocking a portion of the air flowing through the cold air guide part 220 to reduce the amount of cold air.

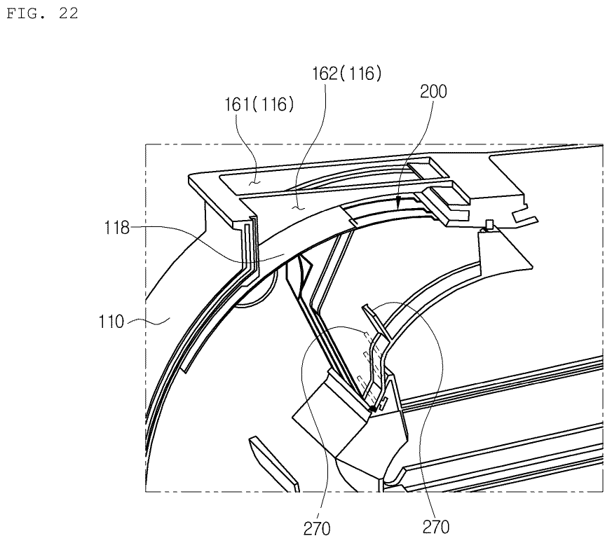

As illustrated in FIG. 22, it is necessary to optimize the position of the cold air blocking baffle 270. If the cold air blocking baffle 270 is positioned at the dotted lines illustrated in the drawing, the cold air blocking baffle 270 may excessively restrict airflow during the vent mode, resulting in airflow loss. Therefore, it is preferable to position the cold air blocking baffle 270 downstream in the cold air flow direction rather than a starting point of the cold air guide part 220 of the temperature channel 200.

The cold air guide baffle 280 acts to induce the cold air passing through the cooling heat exchanger toward the downstream side of the heating heat exchanger, increasing static pressure downstream of the heating heat exchanger. The cold air guide baffle 280 is formed within the warm air guide part 230 and extends side by side with the sliding direction of the vent door 118 on the body part 210 to direct air from the cold air passage toward a downstream space of the heating heat exchanger. That is, through the configuration of the cold air guide baffle 280, cold air is guided downstream of the electric heater 114 via the warm air guide part 230, raising the static pressure in the downstream space of the electric heater 114.

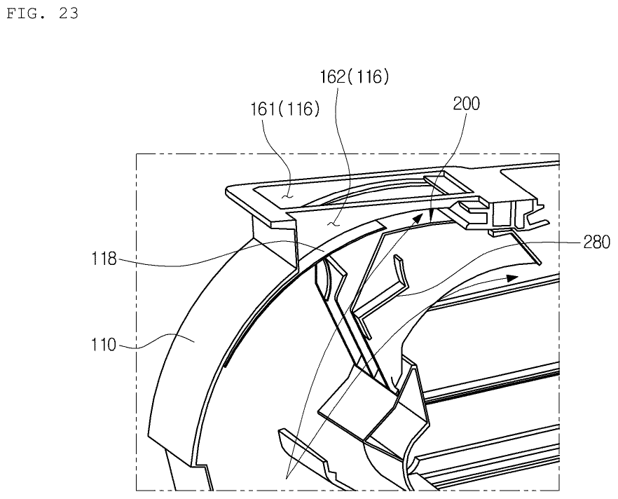

As illustrated in FIG. 23, during the vent mode or the bi-level mode, where the face vent 116 is open, the cold air is directed downstream of the electric heater 114, increasing the static pressure downstream of the electric heater 114. So, when the internal static pressure differs between the driver's seat and the passenger's seat (left and right sides in the vehicle width direction), the cold air guide baffle 280 can minimize the effects of air backflow from the opposite side of the separator, which could influence the fixed side of the temperature door 112.

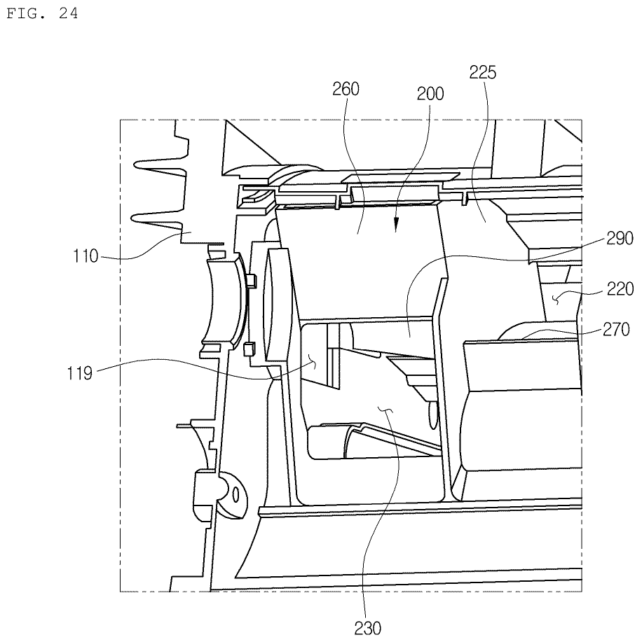

The floor cold air guide baffle 290 guides the cold air passing through the cooling heat exchanger toward the floor vent 119. The floor cold air guide baffle 290 is formed within the warm air guide part 230 and is inclined at a predetermined angle on the body part 210 to guide the air from the cold air passage toward the floor vent 119. As illustrated in FIG. 24, the inclination angle of the floor cold air guide baffle 290 is formed to direct air toward the discharge port of the floor vent 119.

Such a configuration allows the temperature at the discharge port of the side vent 161 to be increased during the bi-level mode, thereby improving the right-left temperature difference performance. Additionally, the configuration can reduce the amount of the cold air flowing through the cold air guide part 220 of the temperature channel 200, thus increasing the discharge temperature. In addition, the air conditioner for the vehicle can raise the static pressure in the downstream space of the electric heater, thus minimizing the influence of warm air crossing to the opposite side of the separator during the dual control for the driver's seat and the passenger's seat.

The air conditioner for a vehicle according to the present invention has been described with reference to the embodiments shown in the drawings, but the embodiments are merely examples. It should be apparent that modifications and variations can be made by persons skilled without deviating from the spirit or scope of the present invention. Therefore, the true scope of technical protection should be defined by the spirit of the appended claims.

What is claimed is:

1. An air conditioner for a vehicle comprising:
an air conditioning case in which an air passage and a plurality of air discharge ports are formed; and
a cooling heat exchanger and a heating heat exchanger sequentially arranged in the air passage of the air conditioning case in an airflow direction,
wherein the air discharge ports include a defrost vent and a face vent, and
wherein a temperature channel is provided in an air passage inside the air conditioning case to guide cold air passing through the cooling heat exchanger to direct the discharge port of the defrost vent and guide warm air passing through the heating heat exchanger to direct the discharge port of the face vent.

2. The air conditioner according to claim 1, wherein the temperature channel includes:
a cold air guide part which guides the cold air passing through the cooling heat exchanger toward the discharge port of the defrost vent; and
a warm air guide part which guides the warm air passing through the heating heat exchanger toward the discharge port of the face vent.

3. The air conditioner according to claim 2, wherein the cold air guide part prevents the warm air passing through the heating heat exchanger from directly moving toward the defrost vent and guides the cold air passing through the cooling heat exchanger to move to the discharge port of the defrost vent.

4. The air conditioner according to claim 2, wherein the defrost vent and the face vent are formed above the heating heat exchanger and face a warm air passage, the face vent is positioned further rearward in the vehicle than the defrost vent, and a cold air passage passing through the cooling heat exchanger is positioned further rearward in the vehicle than the warm air passage passing through the heating heat exchanger, and
wherein the temperature channel is separately formed and coupled directly below the discharge port of the face vent in the air conditioning case.

5. The air conditioner according to claim 2, wherein a vent door is formed to slide and adjust the opening degree of the face vent,
wherein the temperature channel includes a plate-shaped body part corresponding to a sliding path of the vent door,
wherein the warm air guide part is formed to penetrate the body part in the thickness direction, and
wherein the cold air guide part is formed along the sliding path of the vent door on the body part.

6. The air conditioner according to claim 5, wherein the warm air guide part penetrates both sides of the body part in the thickness direction to connect the face vent with the warm air passage.

7. The air conditioner according to claim 5, wherein a plurality of vertical partition walls protruding in the thickness direction is formed on one surface of the body part,
wherein the vertical partition walls are spaced apart in the vehicle width direction,
wherein the cold air guide part is formed in a space between the vertical partition walls, and
wherein the cold air guide part and the warm air guide part are partitioned by the vertical partition walls.

8. The air conditioner according to claim 7, wherein the warm air guide part, the cold air guide part, and another warm air guide part are sequentially arranged in the temperature channel in the vehicle width direction, so that the cold air guide part is positioned between the warm air guide parts.

9. The air conditioner according to claim 7, wherein the warm air guide part, the cold air guide part, another warm air guide part, and another cold air guide part are sequentially arranged in the temperature channel in the vehicle width direction, so that the cold air guide parts and the warm air guide parts are alternately arranged in the vehicle width direction.

10. The air conditioner according to claim 7, wherein the warm air guide part is positioned further toward the side than the cold air guide part in the vehicle width direction.

11. The air conditioner according to claim 7, wherein the face vent includes a center vent and a side vent in the vehicle width direction, and
wherein the center vent and the side vent are respectively arranged to correspond to at least one of the cold air guide part and the warm air guide part in the vehicle width direction.

12. The air conditioner according to claim 1, wherein the air discharge port includes a floor vent provided on the side of the air conditioning case,
wherein the temperature channel includes a floor air guide part which guides the warm air passing through the heating heat exchanger to the discharge port of the floor vent, and
wherein the floor air guide part is formed on the outermost side of the temperature channel in the vehicle width direction.

13. The air conditioner according to claim 5, wherein a horizontal partition wall crosses a through hole of the warm air guide part in the vehicle width direction to partially block the warm air guide part, and
wherein the horizontal partition wall is positioned to correspond to the end of the vent door in the sliding direction of the vent door during a bi-level mode where air is discharged to the face vent and the floor vent.

14. The air conditioner according to claim 7, wherein the face vent includes a center vent and a side vent in the vehicle width direction,
wherein a constant discharge hole which allows air to continuously flow to the side vent is formed in the vent door, and
wherein during the air conditioning mode which closes the face vent, the constant discharge hole is positioned inside the warm air guide part to be exposed to the through-hole of the warm air guide part.

15. An air conditioner for a vehicle comprising:
an air conditioning case in which an air passage and a plurality of air discharge ports are formed; and
a cooling heat exchanger and a heating heat exchanger sequentially arranged in the air passage of the air conditioning case in an airflow direction,
wherein the air discharge ports include a defrost vent and a face vent,
wherein a constant discharge hole is formed in a vent door adjusting the opening degree of the face vent to allow air to be continuously discharged to the face vent, and
wherein a temperature channel is provided in an air passage inside the air conditioning case to suppress cold air passing through the cooling heat exchanger from being discharged through the constant discharge hole.

16. The air conditioner according to claim 15, wherein the temperature channel guides the cold air passing through the cooling heat exchanger toward the discharge port of the defrost vent and guides the warm air passing through the heating heat exchanger toward the discharge port of the face vent,
wherein the temperature channel includes a warm air passage partition which blocks the cold air from being discharged to the constant discharge hole during a bi-level mode, where air is discharged to the face vent and a floor vent, and
wherein the warm air passage partition crosses the through-hole of a warm air guide part in the vehicle width direction to partially block the warm air guide part.

17. The air conditioner according to claim 16, wherein the vent door is formed to slide and adjust the opening degree of the face vent, the temperature channel includes a plate-shaped body part corresponding to the sliding path of the vent door, the body part has a plurality of vertical partition walls protruding on one side of the body part in the thickness direction and spaced apart in the vehicle width direction, and the face vent includes a center vent and a side vent provided in the vehicle width direction, and
wherein the warm air passage partition is formed on the body part at a position corresponding to the side vent to protrude from the vertical partition walls in the thickness direction of the vent door, thus blocking airflow between the cold air passage and the constant discharge hole.

18. The air conditioner according to claim 15, wherein the temperature channel includes a cold air blocking baffle which reduces the amount of cold air discharged to the face vent during the bi-level mode where the air is discharged to the face vent and the floor vent,
wherein the vent door is formed to slide and adjust the opening degree of the face vent, the temperature channel includes a plate-shaped body part corresponding to the sliding path of the vent door, the body part has a plurality of vertical partition walls protruding on one side of the body part in the thickness direction and spaced apart in the vehicle width direction, and the face vent includes a center vent and a side vent provided in the vehicle width direction, and
wherein the cold air blocking baffle is formed protruding from the body part in the thickness direction of the vent door, crossing the cold air guide part in the vehicle width direction.

19. The air conditioner according to claim 15, wherein the temperature channel includes a cold air guide baffle which induces the cold air passing through the cooling heat exchanger toward the downstream side of the heating heat exchanger, increasing static pressure downstream of the heating heat exchanger,
wherein the vent door is formed to slide and adjust the opening degree of the face vent, and the temperature channel includes a plate-shaped body part corresponding to the sliding path of the vent door, and
wherein the cold air guide baffle is formed within the warm air guide part and extends side by side with the sliding direction of the vent door on the body part to direct air from the cold air passage toward a downstream space of the heating heat exchanger.

20. The air conditioner according to claim 15, wherein the air discharge port includes a floor vent provided on the side of the air conditioning case,
wherein the temperature channel includes a floor cold air guide baffle which guides the cold air passing through the cooling heat exchanger toward the floor vent,
wherein the vent door is formed to slide and adjust the opening degree of the face vent, and the temperature channel includes a plate-shaped body part corresponding to the sliding path of the vent door, and
wherein the floor cold air guide baffle is formed within the warm air guide part and is inclined at a predetermined angle on the body part to guide the air from the cold air passage toward the floor vent.
